(19) United States
(12) Patent Application Publication
(10) Pub. No.: US 2014/0171722 A1
(43) Pub. Date: Jun. 19, 2014

(54) INTEGRATED TREATMENT OF TAILINGS IN OILSANDS MINING OPERATIONS

(71) Applicant: Bin-Siew Lim, Vancouver (CA)

(72) Inventor: Bin-Siew Lim, Vancouver (CA)

(21) Appl. No.: 14/102,653

(22) Filed: Dec. 11, 2013

Related U.S. Application Data
(60) Provisional application No. 61/736,741, filed on Dec. 13, 2012.

(51) Int. Cl. C02F 11/14; C04B 18/12

(52) U.S. Cl. CPC C02F 11/14; C04B 18/12
USPC 588/256; 106/638

(57) ABSTRACT

A method for disposal of Mature Fine Tailings (MFT) from oilsands or other mining operations, comprising: i) providing MFT from a source of MFT; ii) adding a viscosity enhancer to the MFT to increase the viscosity of the MFT; iii) adding a hardening agent to the MFT to increase the strength of said MFT; iv) disposing of the MFT on open ground or underground. Prior to the viscosity enhancement step, the MFT may be thickened by vacuum evaporation, hydrocloning and/or centrifuging. Coarse Sand Tailings (CST) may be added to the MFT prior to disposal step to form a pumpable slurry.

### REFERENCE TO RELATED APPLICATION

The present application claims the benefits, under 35 U.S.C.§119(e), of U.S. Provisional Application Ser. No. 61/736,741 filed Dec. 13, 2012 which is incorporated herein by this reference.

### TECHNICAL FIELD

The invention relates to the field of treatment of tailings from oilsands mining operations and mineral mining operations, and in particular the use of vacuum evaporation in such treatment.

### BACKGROUND

In mineral and oilsands mining operations, large quantities of tailings (liquid and solid wastes) are generated. Generally, the liquid wastes are stored in tailings ponds constructed out of the solid wastes. The liquid wastes consist of water, chemicals and fine solid particles (silt, clay and clay-sized particles). Because of the minute size of the fine solid particles, it takes a long time for the fine solid particles to settle out to the point where the water can be recycled and reused.

Oilsands consist of solids (fine sand, silt, clay and clay-sized particles), bitumen and a trace amount of water. Typically, in oilsands mining operations, bitumen is extracted from the oilsands using a hot water process. Hot water, chemicals and solvents are added to the oilsands to allow the extraction of the bitumen from the oilsands. Three waste streams result from this extraction process: namely, Coarse Sand Tailings (CST), Thickened Tailings (TT) and Tailings Solvent Recovery Unit (TSRU) tailings.

At the tailings pond location, solids from the CST are separated out for using to construct the dyke surrounding the tailings pond and the liquid waste (Thin Fine Tailings—TFT) flows into the tailings pond. Mature Fine Tailings (MFT) result from the settling out of fine solid particles in the TFT. Typically, MFT contains about 30-35% of fine solid particles after a few years. Further increase in fine concentration through natural settling process will take a very long time. As such, oilsands mining operators are obliged to maintain and be responsible for the tailings ponds for a very long time. Both TT and TSRU waste streams are discharged directly into the tailings pond for storage.

Typically, MFT are treated with flocculants or coagulants to flocculate/coagulate the clay and clay-sized particles to help bleed out excess water and accelerate settling of the fine particles. The flocculated/coagulated fine particles are deposited on open ground and allowed to dry out further. The bled water is pumped back to the tailings pond for storage. Typically, this process can bring the solid concentration up to about 60% and takes significant time as the process is dependent on natural process and weather.

The MFT so thickened are sometimes blended with CST prior to final disposal. Because of the nature of the MFT/CST blend, segregation sometimes occurs and the mixture is difficult to pump. The MFT/CST blend also gains strength very slowly through natural process and weather.

Other processes such as hydrocycloning and centrifuging have been tried and found unable to achieve the desired solid concentration within time and economic constraints.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention therefore provides an integrated method of dewatering tailings from oilsands or other mining operations using addition of viscosity enhancers and hardening agents to tailings followed by blending with tailings. It deals particularly with treatment of tailings from oilsands mining operations. But it is equally applicable to treatment of tailings from mineral mining operations.

More particularly the invention is directed to method of disposal of MFT from oilsands or other mining operations, comprising: i) providing MFT from a source of MFT; ii) adding a viscosity enhancer to the MFT to increase the viscosity of the MFT; iii) adding a hardening agent to the MFT to increase the strength of said MFT; iv) disposing of the MFT on open ground or underground. According to one aspect of the invention, prior to the viscosity enhancement step, the MFT is thickened MFT by vacuum evaporation, hydrocloning and/or centrifuging. According to a further aspect of the invention, prior to the disposal step, additional particulate solids such as Coarse Sand Tailings (“CST”) are added to the MFT to form a pumpable slurry.

According to a further aspect of the invention there is provided a pumpable slurry for disposal of Mature Fine Tailings (“MFT”) and Coarse Sand Tailings (“CST”) from oilsands or other mining operations, comprising: i) MFT from a source of MFT; ii) a viscosity enhancer to increase the viscosity of the MFT; and iii) a hardening agent to increase the strength of the MFT. The pumpable slurry may further include additional particulate solids such as CST.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a schematic diagram illustrating the method and system of the invention.

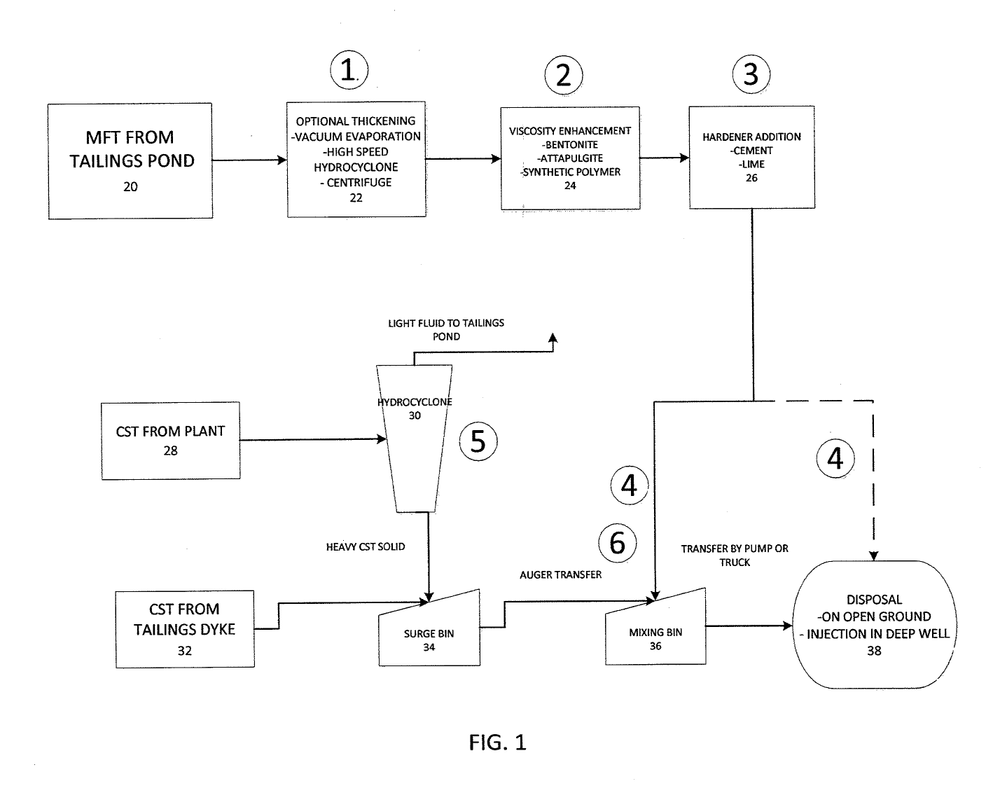

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The treatment described herein integrates several processes which, when combined, render MFT into a mixture for safe disposal. The described thickening, addition of viscosity enhancers and hardening agents to MFT will result in a stable viscous fluid suitable for use in transporting solids such as CST as a pumpable slurry. The MFT/Viscosity Enhancers/Hardening Agents blended fluid can be pumped to disposal site 38 for final deposition or added to the CST from the plant or tailings pond to create a relatively stiff but stable and pumpable mixture. This final mixture can be pumped or delivered by trucks to disposal site 38 for final deposition.

The time required for the blended fluid or mixture to gain strength is dependent on the amount of hardening agents added. Generally, rate of strength increases with increased amount of hardening agents.

The proposed treatment of MFT and blending with CST is shown on the attached schematic. The sequence of steps described below results in optimal blending of all the components.

### 1. Thickening Process

MFT is drawn from the tailings pond at 20 and optionally goes through thickening processes at 22 such as:
1 Vacuum Evaporation—The liquid/solid mixture is placed in a vessel where a vacuum is applied. Liquid phase within the mixture evaporates with the increase of vacuum resulting in thickened mixture or dry solid. A novel method of vacuum evaporation of MFT is disclosed in the present inventor's co-pending application Ser. No. 61/700,586 entitled APPLICATION OF VACUUM EVAPORATION TO THE THICKENING AND DRYING OF TAILINGS IN OILSANDS AND MINERAL MINING OPERATIONS which is incorporated herein by this reference.
2 High Speed Hydrocyclones and Centrifuges—Hydrocyclone or centrifuging processes are used in many industries to separate liquids and solids of different density and sizes. Equipment used in such processes is fairly standard and commonly available. Typically in a hydrocyclone process, a mixture of liquids/solids of different density and size is injected into a cyclone with centrifugal pump. The speed of injection is dependent on the desired separation. The mixture may go through several cyclones arranged in series to separate out liquids/solids of several different densities and sizes. Typically, MFT is a mixture of water, fine sand, silt and clay. With the use of high speed hydrocyclones and/or centrifuges, it is possible to reduce the amount of water in the mixture resulting in a thickened MFT.
3 Chemicals can also be added to the MFT at this stage to flocculate the clay particles and help in separating the water from the mixture.

Depending on the tailings disposal philosophy and objective of the oilsands mine operators, the degree and scope of thickening may be reduced or omitted as the subsequent treatment processes described below will also treat the liquid phase of MFT and removes the need to return the bled water to storage or treatment.

### 2. Viscosity Enhancer Addition

Viscosity enhancers such as bentonite, attapulgite, synthetic polymers and other additives typically used in drilling industry are added to the MFT at 24. Typically, 2-5% by weight equivalence of fluid phase of MFT is adequate to achieve the desired viscosity. For example, in 1,000 kg of MFT with 30% solid content, there is 300 kg. of solid particles and 700 kg. of fluid phase. This means that about 14 to 35 kg. of viscosity enhancers will be required to increase the viscosity of the subject MFT to a level that it will improve its capacity to suspend and transport additional solid particles.

Mixing and hydrating of the viscosity enhancers is typically achieved by re-circulating the fluid mixture through high speed centrifugal pumps. Depending on the design of the mixing equipment and the viscosity enhancer used, total blending and hydration may take 3 to 10 recirculations though the mixing pump.

This process is very different from conventional treatment of MFT. The differences and advantages between the two are outlined as follows:
1 Viscosity Gain—In the presently disclosed treatment, viscosity is increased with addition of viscosity enhancers; whereas in conventional treatment, viscosity is increased by reducing water content through addition of flocculants or coagulants.
2 Viscosity Gain Predictability—In the presently disclosed treatment, viscosity gain is dependent on the interaction between the viscosity enhancers and the fluid of the MFT. The chemistry of fluid of MFT is relatively stable. Hence, the viscosity gain is more predictable once the suitable viscosity enhancers have been chosen through experimentation. In conventional treatment, viscosity gain through reduction of water resulted from interaction between flocculants or coagulants and clay particles of MFT, which is less predictable because of variable mineralogy of the clay in MFT and sensitivity of the results to the dosage of flocculants or coagulants.

### 3. Hardening Agent Addition

In this step of the treatment, strength gain and development is achieved through the addition of hardening agents such as cement and lime at 26; whereas in conventional treatment, strength is generally gained through consolidation of the mixture under its own weight. Typically, addition of hardening agents in the amount of about 10% weight equivalence of the fluid phase of MFT is adequate to achieve the desired strength. For example, in 1,000 kg of MFT with 30% solid content, there is 300 kg. of solid particles and 700 kg. of fluid phase. This means that about 70 kg. of hardening agent will be required to achieve the target strength when the mixture cures.

Depending on the design of the mixing equipment, total blending of the hardening agents may take 2 to 3 recirculations through the mixing pumps.

Presently, Energy Resources Conservation Board (ERCB) of Alberta, Canada requires minimum strength of 5 kPa (0.723 psi) for the final mixture for disposal by hardening. v The differences and advantages between the conventional and disclosed treatment methodologies are outlined as follow:
1 Strength Gain & Development—In the disclosed method, the strength gain is dependent on the amount of hardening agents added to the MFT. This is typically expressed as a percentage of the fluid phase of the MFT. The strength gain and optimization can be predicted through laboratory experimentation. The higher the percentage of hardening agents added to the MFT, the higher the strength gains and the faster the strength develops. Initial strength gain may be noticeable in a few hours and final strength gain may be achieved in a few days.
2 The process is completely independent of natural processes and is highly predictable.

In conventional treatment, strength gain is achieved through consolidation of the mixture under its own weight. Strength development is highly unpredictable as it is totally dependent on natural processes.

As Step 4., the blended mixture of MFT, viscosity enhancer and hardening agent can be disposed of at 38 on open ground for final curing or injected into deep wells for disposal. Per current ERCB requirement, the mixture can be disposed of this way if the mixture can attain a minimum strength of 5 kPa in a year. It can also or alternatively be transferred by pump or truck and stored in temporary surge bins/mixing bin at 36 for further processing as outlined below.

As a Step 5. in parallel, CST 28 from the plant can be processed through a high speed hydrocyclone 30 at the plant to deliver relatively dry CST to a surge bin 34. Dry CST 32 from the tailings dyke can also be delivered by truck from the tailings dyke to the surge bin 34. The contents of surge bin 34 can then be transferred to mixing bin 36 by auger transfer or otherwise.

CST and blended mixture of MFT, viscosity enhancer and hardening agent are metered into the mixing bin 36 at Step 6. to produce a relatively stiff but pumpable mixture. A typical mix ratio of CST to blended MFT is from 3 to 1 by weight to 5 to 1 by weight. The final mixture can be disposed of as a pumpable slurry on open ground as per ERCB's criterion listed in Step 4, or injected into deep wells for disposal.

The presently disclosed integrated treatment process offers several advantages over other conventional treatment processes, namely:
a. The process is fully under the control of the oilsands mining operators.
b. Quality and quantity of blended mixture of MFT, viscosity enhancer and hardening agent can be pre-determined to meet the needs of the oilsands mining operators.
c. Process equipment can be easily standardized and scaled to meet the needs of the oilsands mining operators.
d. The process will produce a stable mixture that can be pumped easily with conventional pumping equipment. This potentially reduces handling cost.
e. The process equipment requires minimal land space.
f. The hardened cured mixture is stable and relatively impervious and impermeable. Depending on the hardening agent used, the hardened cured mixture may trap or fix the harmful chemicals in the mixture thus reducing the risk of contaminating the native ground adjacent to the disposal sites.

cases where the oilsands mines are located over unstable or pervious artesian formation, deep well injection disposal method can help to reduce the risk of instability of the floor of the mines or ingress of groundwater from pervious artesian formation (aquifer) located below the floor of the mines.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method of disposal of Mature Fine Tailings (“MFT”) from oilsands or other mining operations, comprising:
i) providing MFT from a source of MFT;
ii) adding a viscosity enhancer to said MFT to increase the viscosity of said MFT;
iii) adding a hardening agent to said MFT to increase the strength of said MFT;
iv) disposing of said MFT above ground, in ground or underground.

2. The method of claim 1 comprising the further step, prior to said viscosity enhancement step, of thickening said MFT by vacuum evaporation, hydrocloning and/or centrifuging.

3. The method of claim 1 comprising the further step, prior to said disposal step, of adding additional particulate solids to said MFT to form a pumpable slurry.

4. The method of claim 3 wherein said additional particulate solids comprise Coarse Sand Tailings (“CST”).

5. The method of claim 1 wherein said MFT are provided by being drawn from a tailings pond.

6. The method of claim 1 wherein said viscosity enhancer is selected from the group consisting of bentonite, attapulgite, and synthetic polymers.

7. The method of claim 1 wherein said hardening agent is selected from the group consisting of cement and lime.

8. The method of claim 1 wherein the amount of said viscosity enhancer which is added to said MFT is about 2-5% by weight equivalence of the fluid phase of said MFT

9. The method of claim 1 wherein the amount of said hardening agent which is added to said MFT is about 10% by weight equivalence of the fluid phase of said MFT

10. The method of claim 4 wherein said CST is sourced from the oilsands separation plant and processed through a high speed hydrocyclone.

11. The method of claim 4 wherein said CST is sourced from a tailings dyke.

12. The method of claim 3 wherein said additional particulate solids are added to said MFT in a mixing bin prior to disposal.

13. The method of claim 4 wherein said CST is added to said MFT in a ratio of from 3 to 1 by weight to 5 to 1 by weight.

14. A pumpable slurry for disposal of Mature Fine Tailings (“MFT”) and Coarse Sand Tailings (“CST’) from oilsands or other mining operations, comprising:
i) MFT from a source of MFT;
ii) a viscosity enhancer to increase the viscosity of said MFT; and
iii) a hardening agent to said MFT to increase the strength of said MFT.

15. The pumpable slurry of claim 14 further comprising additional particulate solids.

16. The pumpable slurry of claim 15 wherein said additional particulate solids comprise CST.

17. The pumpable slurry of claim 14 wherein said viscosity enhancer is selected from the group consisting of bentonite, attapulgite, and synthetic polymers.

18. The pumpable slurry of claim 14 wherein said hardening agent is selected from the group consisting of cement and lime.

19. The pumpable slurry of claim 14 wherein the amount of said viscosity enhancer which is added to said MFT is about 2-5% by weight equivalence of the fluid phase of said MFT.

20. The pumpable slurry of claim 14 wherein the amount of said hardening agent which is added to said MFT is about 10% by weight equivalence of the fluid phase of said MFT.

21. The pumpable slurry of claim 16 wherein said CST is sourced from the oilsands separation plant and processed through a high speed hydrocyclone.

22. The pumpable slurry of claim 16 wherein said CST is sourced from a tailings dyke.

23. The pumpable slurry of claim 16 wherein the ratio of CST to MFT is from 3 to 1 by weight to 5 to 1 by weight.

24. The pumpable slurry of claim 14 wherein said MFT is drawn from a tailings pond.

25. The pumpable slurry of claim 14 wherein said MFT is thickened by vacuum evaporation, hydrocloning and/or centrifuging.
